(19) United States
(12) Patent Application Publication
(10) Pub. No.: US 2006/0139290 A1
(43) Pub. Date: Jun. 29, 2006

(54) Dual single-ended driven liquid crystal display and driving method thereof

(75) Inventors: Min-Feng Chiang, Sinjhuang City (TW); Hsueh-Ying Huang, Sanchong City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/086,544

(22) Filed: Mar. 22, 2005

(30) Foreign Application Priority Data
Dec. 24, 2004 (TW) 93140677

(51) Int. Cl. G09G 3/36

(52) U.S. Cl. 345/100

(57) ABSTRACT

A dual single-ended driven LCD and driving method thereof are provided. The LCD comprises a pixel, a data line, a first scan driver, a second scan driver, a first scan line and a second scan line. The pixel comprises a first and a second switches. The control ends of the first and the second switches are electrically connected to the first and the second scan lines respectively. The first scan driver is located on one side of the pixel and is electrically connected to the first scan line. The second scan driver is located on another side of the pixel and is electrically connected to the second scan line. The first scan driver and the second scan driver respectively drive the first and the second scan lines. The data line is electrically connected to the first the second switches for transmitting image data to the pixel.

This application claims the benefit of Taiwan application Serial No. 93140677, filed Dec. 24, 2004, the subject matter of which is incorporated herein by reference.

### BACKGROUND OF THE INVENTION

1. Field of the Invention

The invention relates in general to a liquid crystal display (LCD) and driving method thereof, and more particularly to a dual single-ended driven LCD and driving method thereof.

2. Description of the Related Art

FIG. 1A is a block diagram of a conventional single-ended driven liquid crystal display (LCD). LCD 100 comprises a data driver 130, a scan driver 120 and a panel 110. The data driver 130 comprises a plurality of data lines L for transmitting image data to the panel 110. The scan driver 120 comprises a plurality of scan lines G for driving the panel 110 from one side of the panel 110. The panel 110 comprises a plurality of pixels 112 arranged in a matrix and electrically connected to the corresponding scan line G and the corresponding data line L respectively. When the corresponding scan line G of one pixel 112 is enabled, the pixel 112 can receive image data from the corresponding data line L and have the received image data displayed.

FIG. 1B is a diagram of an equivalent circuit of the pixel 112. The pixel 112 comprises a transistor Q and a display unit. The display unit is exemplified by a liquid crystal capacitor Clc and a storage capacitor Cst here. The gate electrode of the transistor Q is electrically connected to its corresponding scan line G, the source electrode of the transistor Q is electrically connected to the liquid crystal capacitor Clc and the storage capacitor Cst, and the drain electrode of the transistor Q L is electrically connected to its corresponding data line. When the scan driver 120 activates an impulse signal P to enable a scan line G, all transistors Q on the scan line G would be turned on. When the transistor Q is turn on, the image data from the data driver 130 would be transmitted to the liquid crystal capacitor Clc and the storage capacitor Cst through the transistor Q.

The LCD 100 disclosed above uses a single-ended driving method according to prior art, i.e., uses a scan driver 120 to drive the panel 110 from one side. Due to the resistance and stray capacitance on the scan line G, the impulse signal P will decay when transmitted on the scan line G, and this is normally called the gate delay.

Referring to FIG. 2, a diagram showing the transmission of signals on a scan line G is shown. The impulse signal P observed from the front end of the scan line G, point A on the panel for instance, is a sound squared wave. However, when observed from the terminal end of the scan line G, point B for instance, gate delay would occur to the impulse signal P′ causing severe distortion, resulting in an insufficient charging time to the pixels on the terminal end and a deteriorated display quality.

Due to the parasitic capacitance of the thin film transistor (TFT), a feed through voltage is generated and the voltage of the pixel electrode is reduced during the split of second when the thin film transistor is turned off. The longer the gate delay, the smaller the feed through voltage on the terminal end of the pixel, causing an uneven distribution of the feed through voltage on the panel and a deteriorated display quality.

### SUMMARY OF THE INVENTION

According to the object of the invention, a liquid crystal display (LCD) and driving method thereof are provided to improve the LCD gate delay problem and enhance the display quality of dynamic images.

It is therefore an object of the invention to provide a dual single-ended driven LCD, comprising a pixel, a first scan line, a second scan line, a data line, a first scan driver and a second scan driver. The pixel comprises a first switch and a second switch. The first scan line is electrically connected to the first switch. The second scan line is electrically connected to the second switch. The data line is electrically connected to the first switch and the second switch for transmitting image data to the pixel. The first scan driver is located on one side of the pixel and is electrically connected to the first scan line. The second scan driver is located on another side of the pixel and is electrically connected to the second scan line.

It is another object of the invention to provide a dual single-ended driving method. At first, a first scan driver and a second scan driver are used for outputting a first and a second impulse signals respectively to the first and the second scan lines respectively to turn on the first and the second switches. Next, a data driver is used for outputting image data to the data line to be transmitted to the first and the second switches. Then, the image data are respectively inputted into the display unit via the first and the second switches.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (prior art) is a block diagram of a conventional single-ended driven LCD;

FIG. 1B (prior art) is a diagram of an equivalent circuit of a pixel;

FIG. 2 is a diagram showing the transmission of signals on a scan line;

FIG. 3A is a block diagram of a dual single-ended driven LCD according to a preferred embodiment of the invention;

FIG. 3B is a diagram of an equivalent circuit of a pixel according to the preferred embodiment of the invention;

FIG. 4 is a diagram showing the signal transmission on scan lines G1 and G2;

FIG. 5 is a diagram showing the repairing of a damaged scan line according to the preferred embodiment of the invention; and

FIG. 6 is a pixel layout according to the preferred embodiment of the invention.

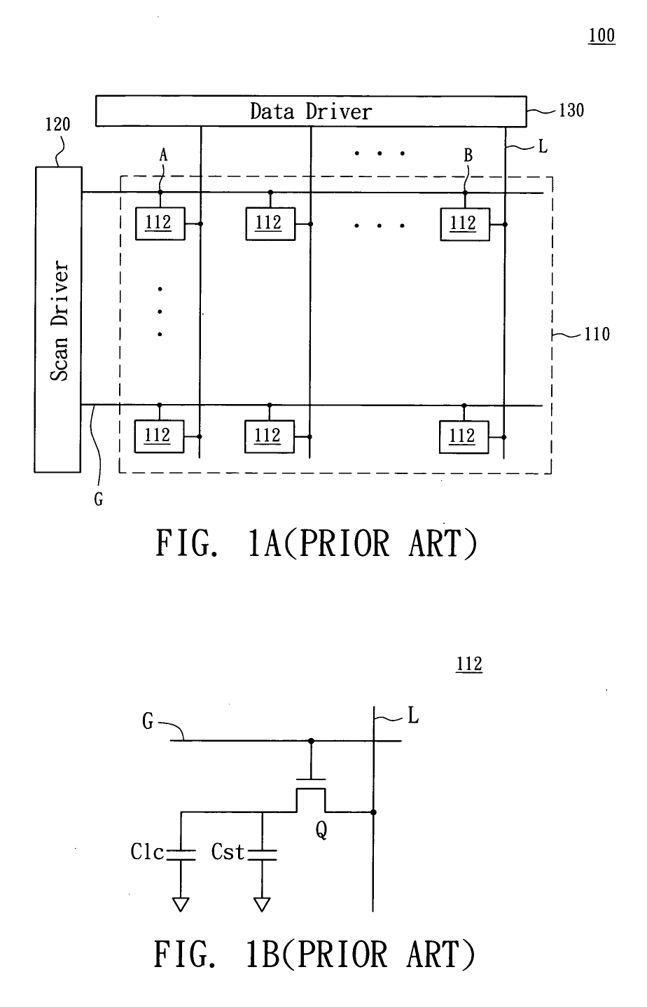

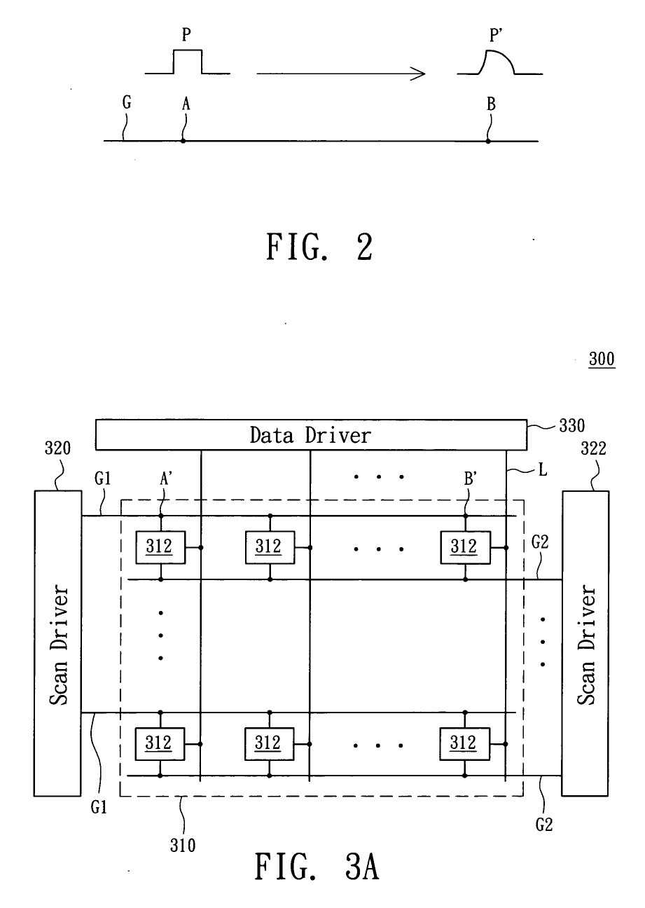

### DETAILED DESCRIPTION OF THE INVENTION

Referring to FIG. 3A, a block diagram of a dual single-ended driven liquid crystal display (LCD) according to a preferred embodiment of the invention is shown. LCD 300 comprises a data driver 330, scan drivers 320 and 322 and a panel 310. The data driver 330 is electrically connected to a plurality of data lines L for transmitting image data to the panel 310. The scan drivers 320 and 322, which are respectively coupled to a plurality of scan lines G1 and G2 driving the panel 310 from the two sides of the panel 310 respectively. The panel 310 comprises a plurality of pixels 312 arranged in a matrix. The pixels 312 are electrically connected to the corresponding data line L and the corresponding scan lines G1 and G2 respectively. When the corresponding scan line G1 or the corresponding scan line G2 of a pixel 312 is enabled, the pixel 312 would receive the image data from the corresponding data line L and have the received image data displayed.

FIG. 3B is a diagram of an equivalent circuit of a pixel 312 according to the preferred embodiment of the invention. Each of the pixels 312 at least comprises two switches, a liquid crystal capacitor Clc and a storage capacitor Cst. The two switches are transistor Q1 and Q2. The first ends (the source electrode or the drain electrode) of the transistors Q1 and Q2 are electrically connected to a corresponding data line L, while the second ends (the drain electrode or the source electrode) are electrically connected to the liquid crystal capacitor Clc and the storage capacitor Cst. The control end the (gate electrode) of the transistor Q1 is electrically connected to a corresponding scan line G1 to be controlled by the scan driver 320. The control end (gate electrode) of the transistor Q2 is electrically connected to a corresponding scan line G2 to be controlled by the scan driver 322. That is to say, the pixels 312 are controlled by the scan drivers 320 and 322 at the same time and can receive the image data from the data line L as long as one of the corresponding scan lines G1 and G2 is enabled.

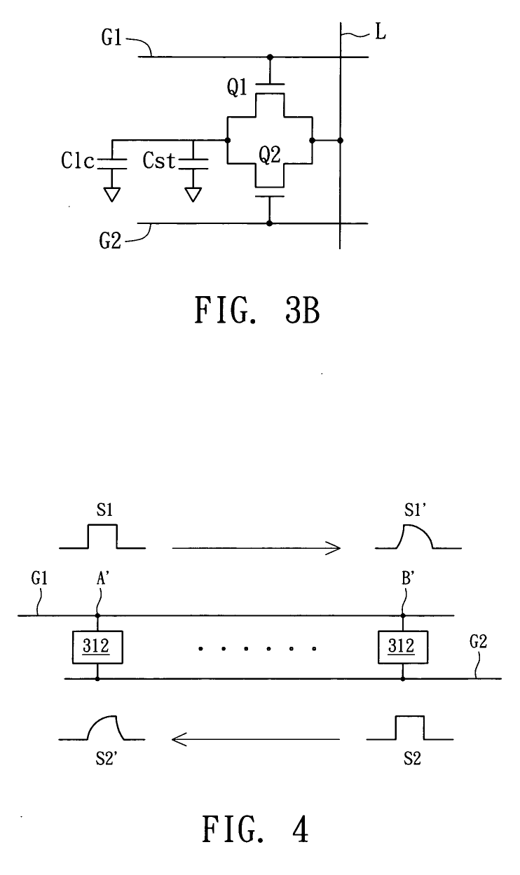

The scan drivers 320 and 322 operate simultaneously, that is to say, the scan drivers 320 and 322 simultaneously output impulse signals S1 and S2 to respectively enable scan lines G1 and G2 located on the same horizontal line. Referring to FIG. 4, a diagram showing the signal transmission on scan lines G1 and G2 is shown. Observed from the front end of the scan line G1, i.e. point A′ on the panel for instance, the impulse signal S1 is a sound squared wave. However, due to the interference of resistance and stray capacitance occurring to the scan line G1, the impulse signal S1′ shows a severe distortion when observed from the terminal end of the scan line G1, i.e. point B′ for instance. Observed from the front end of the scan line G2, i.e. point B′ on the panel for instance, the impulse signal S2 is a sound squared wave. However, due to the interference of resistance and stray capacitance occurring to the scan line G2, the impulse signal S2′ shows a severe distortion when observed from the terminal end of the scan line G2, i.e. point A′ for instance.

Point A′ of the pixel 312 is controlled by the impulse signals S1 and S2′ at the same time. Despite the distortion occurs to the impulse signal S2′, the pixel 312 still has a sufficient charging time according to the impulse signal S1. Similarly, the point B′ of the pixel 312 is controlled by the impulse signal S1′ and S2 at the same time. Despite the distortion occurs to the impulse signal S1′, the pixel 312 still has a sufficient charging time according to the impulse signal S2. Therefore, the gate delay problem which normally occurs to the pixel on the terminal end of a conventional single-ended driven panel would not occur to the pixel on the terminal end of the dual single-ended driven panel of the present embodiment. Therefore, the problem of an insufficient charging time would be resolved and so would the uneven distribution of the feed through voltage on the panel due to the parasitic capacitance on the thin film transistor (TFT) be improved.

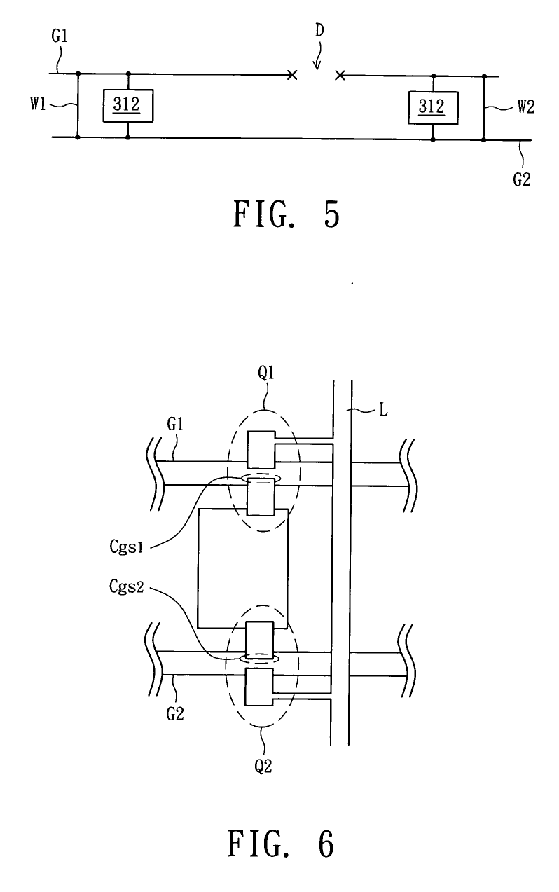

Apart from resolving the above gate delay problem, the invention has another advantage of easily repairing the scan line. The scan line of a conventional single-ended driven panel is not easy to be repaired once broken and such breakage would cause display failure to some of the pixels on the panel. Referring to FIG. 5, a diagram showing the repairing of a damaged scan line according to the present embodiment is shown. Suppose the scan line G1 is corrupted and leaves a rupture at point D. Under such circumstances, the panel of the present embodiment is still able to function normally and the pixels that cannot be driven by the scan line G1 still can be driven by the scan line G2. Besides, the scan lines G1 and G2 can be short-circuited using laser fusion. For example, the wires W1 and W2 in the diagram enable the pixels on the same row to be driven by the gate drivers at two sides of the panel and a quality display still can be achieved.

The third advantage of the invention is to reduce the influence of mask shift during the manufacturing process. Referring to FIG. 6, a pixel layout according to the preferred embodiment of the invention s shown. If the mask of the source electrode/drain electrode, which is a constituent element of the transistors Q1 and Q2, shifts, say shifts downward for example, the capacitor Cgs2 located between the gate electrode and the source electrode of the transistor Q2 would increase along with the increase in the overlapping area of the gate electrode and the source electrode while the capacitor Cgs1 located between the gate electrode and the source electrode of the transistor Q1 would decreases accordingly. Since the capacitance of the capacitor Cgs of the pixel is equal to the sum of the capacitance of the capacitor Cgs1 of the transistor Q1 and the capacitance of the capacitor Cgs2 of the transistor Q2, the capacitance of the capacitor Cgs of the pixel would still remain at a constant value, reducing the negative effect of mask shift.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A dual single-ended driven LCD, comprising:
a pixel comprising a first switch and a second switch;
a first scan line electrically connected to the first switch;
a second scan line electrically connected to the second switch;
a data line, electrically connected to the first switch and the second switch, for transmitting image data to the pixel;
a first scan driver located on one side of the pixel and electrically connected to the first scan line; and
a second scan driver located on another side of the pixel and electrically connected to the second scan line.

2. The LCD according to claim 1, further comprising a data driver electrically connected to the data line.

3. The LCD according to claim 1, wherein the pixel further comprises a pixel electrode.

4. The LCD according to claim 3, wherein the first switch includes a control end coupled to the first scan line, a first end coupled to the data line, and a second end coupled to the pixel electrode.

5. The LCD according to claim 3, wherein the second switch includes a control end coupled to the second scan line, a first end coupled to the data line and a second end coupled to the pixel electrode.

6. The LCD according to claim 1, wherein the first scan driver and the second scan driver, respectively, drive the first scan line and the second scan line according to the same time sequence.

7. The LCD according to claim 1, wherein the first switch is a thin film transistor.

8. The LCD according to claim 1, wherein the second switch is a thin film transistor.

9. The LCD according to claim 1, wherein the first scan line has a first portion electrically connected to the first scan driver and the first switch, and a second portion electrically connected to the second scan line.

10. The LCD according to claim 9, wherein the second scan line has a first portion electrically connected to the second scan driver and the second switch, and a second portion electrically connected to the first portion of the first scan line.

11. A dual single-ended driving method for the LCD according to claim 1, the method comprising:
outputting respectively a first impulse signal and a second impulse signal to the first scan line and the second scan line simultaneously to turn on the first switch and the second switch; and
transmitting image data to the first switch and the second switch.

12. The method according to claim 11, wherein the step of transmitting the image data comprises:
outputting the image data to the data line through a data driver; and
transmitting the image data to the first switch and the second switch through the data line.

13. The method according to claim 11, further comprising inputting the image data to a pixel electrode through the first switch and the second switch, respectively.

14. The method according to claim 11, wherein the first impulse signal is output through the first scan driver, and the second impulse signal is output through the second scan driver.
